(19) United States
(12) Patent Application Publication
(10) Pub. No.: US 2026/0006059 A1
(43) Pub. Date: Jan. 1, 2026

(54) SYSTEMS AND METHODS FOR LOW RANK COMPRESSION OF TRAJECTORY SENSITIVITIES FOR EFFICIENT DYNAMIC SECURITY ASSESSMENT

(71) Applicants: Amarsagar Reddy Ramapuram Matavalam, Tempe, AZ (US); Arnav Bagga, Tempe, AZ (US)

(72) Inventors: Amarsagar Reddy Ramapuram Matavalam, Tempe, AZ (US); Arnav Bagga, Tempe, AZ (US)

(73) Assignee: Arizona Board of Regents on Behalf of Arizona State University, Tempe, AZ (US)

(21) Appl. No.: 19/238,130

(22) Filed: Jun. 13, 2025

Related U.S. Application Data
(60) Provisional application No. 63/665,889, filed on Jun. 28, 2024.

(51) Int. Cl. H04L 9/40

(52) U.S. Cl. CPC H04L 63/1433

(57) ABSTRACT

A systematic methodology is presented based on singular value decomposition (SVD) to store TS data and perform calculations using it to estimate post fault perturbed system trajectories. The obtained results are compared with corresponding non-linear dynamic simulation results. The proposed approach is tested and validated on the IEEE 39-bus as well as the WECC 179 bus system consisting of detailed generator, exciter, and governor models. In support, the size of data associated with TS analysis to effectively aid in DSA is reduced by up to a factor of 65, with error<0.01%. The scalability potential of the approach presented is promising to make TS analysis widespread for operation and planning of large-scale systems.

### CROSS REFERENCE TO RELATED APPLICATIONS

This is a non-provisional application that claims benefit to U.S. Provisional Application Ser. No. 63/665,889, filed on Jun. 28, 2024, which is herein incorporated by reference in its entirety.

### FIELD

The present disclosure generally relates to computing technologies including security assessments; and in particular to scalable approaches for efficient utilization of trajectory sensitivity analysis.

### BACKGROUND

Trajectory sensitivity (TS) is a well-known alternative and powerful approach for performing dynamic security assessment (DSA). With a focus on increasing penetration of inverter-based resources (IBRs) and a long queue of pending generation interconnection requests, large scale and clock time friendly power system planning studies are crucial. A component of these studies requires performing time domain simulations for different system settings. This can be a repetitive, time consuming and computationally intensive process to implement.

It is with these observations in mind, among others, that various aspects of the present disclosure were conceived and developed.

### BRIEF DESCRIPTION OF THE DRAWINGS

FIG. 1 is a pictorial representation of a trajectory sensitivity (TS) matrix, T_{λ}.

FIG. 2 is a proposed compressed singular value decomposition (SVD) approach for TS analysis.

FIG. 3 is a report of SVD truncation decision stage for T_{λ} matrix-% error and compression factor plot vs. rank, k for IEEE 39-bus system.

FIG. 4 is a report of speed deviation trajectory plots at Gen 6, t_{perturb}=3.6 s.

FIG. 5 is a report of generator relative rotor angle trajectories comparison for Gen 3, 5 and 8; k_{truncate}=30 and t_{perturb}=3.6 sec.

FIGS. 6A-6B is a series of graphs illustrating (a & b) Validation plots for fault scenario 1, t_{perturb}=0.22 s.

FIGS. 7A-7B is a series of graphs illustrating (a & b) Validation plots for fault scenario 2, t_{perturb}=0.44 s.

FIG. 8 is an example computing device that can be implemented for various aspects of the inventive concept herein.

Corresponding reference characters indicate corresponding elements among the view of the drawings. The headings used in the figures do not limit the scope of the claims.

### DETAILED DESCRIPTION

The present disclosure relates to inventive concepts associated with implementation of trajectory sensitivity (TS) for dynamic security assessments (DSA), which can take the form of various methodologies including one or more algorithms, and/or devices and combinations thereof. One aim is to apply TS to different power systems, specifically larger systems. It is hoped to resolve issues that result in the post computation stages of TS by utilizing a low rank approximation of TS time-varying matrices. The proposed approach was validated using a compressed singular value decomposition (SVD) approach.

In some examples, exemplary features of the inventive concept include the following.
Consolidation of power system variables using a Taylor series approximation and time domain simulation approach to create the appended TS matrix (where the appended TS matrix is the combination of time-varying matrices or TS system state and algebraic variables)
Using a low rank approximation of the appended TS matrix.
Using the IEEE 39-bus system (also known as the 10-machine New-EnglandPower System) to run test simulations on the proposed parameters

One proposed algorithm of the inventive concept was tested using the IEEE 39-bus system to assess technical improvements afforded by the various methodologies described herein. Testing utilized a three-phase fault of 0.6 s at bus 32 (location of generator 3) with a clearing time instant of 2.6 s. According to the results of the test simulations, the SVD approach reduced the size of the TS matrix approximately 48 times. Furthermore, the computational time to estimate the trajectories (compared to the previous TS approach) was about 10 times faster.

### I. Introduction

Trajectory sensitivity (TS) is a well-known alternative and powerful approach for performing dynamic security assessment (DSA). With a focus on increasing penetration of inverter-based resources (IBRs) and a long queue of pending generation interconnection requests, large scale and clock time friendly power system planning studies are crucial. A component of these studies requires performing time domain simulations for different system settings. This can be a repetitive, time consuming and computationally intensive process to implement. Instead of performing repetitive time domain simulations, TS analysis can be utilized to aid in DSA using a linearized approach. TS linearizes the system along the nominal trajectory rather than an equilibrium point without using the traditional time domain simulation approach for DSA. In simple terms, given base case system trajectories of system states and variables, TS is used to estimate change in those trajectories in response to small changes in system parameters. The amount of trajectory change dictates the sensitivity and thereby vulnerability of system states and variables with respect to different parameters. The system parameters can include system loads, branch reactance, generator parameters such as damping constant or initial conditions of system states.

Over the past few decades, there has been significant research into the theory and applicability of utilizing TS in dynamic system analysis. In one paper, it was methodically shown how to use TS analysis in post fault conditions to perform DSA by using analytical approaches, namely a and B sensitivities. In another paper, TS analysis was utilized to investigate the Nordic power grid disturbance of Jan. 1, 1997. The additional information was retrieved through the powerful system dynamics capturing ability of TS analysis. In other works, the application of TS in power system analysis was explored including estimating unknown or uncertain system parameters, in optimal control problems and merging of stability constraints with optimal power flow (OPF) problem. Other works provide computationally efficient methods to speed up the process of computing TS for various applications. In recent work, one author proposed a preventive control approach to optimally balance wind power variation by rescheduling active power of generators using a TS based approach.

Even though TS is a powerful approach to aid in DSA and in developing fields such as transient stability constrained OPF, its practical use has been limited. One of the reasons is linked to computation of TS for larger systems and has been addressed in previous literature. Another major concern is linked to the post computation stage of TS, i.e., efficient storage and utilization of the TS data to aid in its different applications related to power systems. It is believed that the technical art is devoid of solutions addressing this post computation stage issue related to TS. The present disclosure addresses the pertinent concern by introducing a low rank approach, which is a compressed SVD approach. A systematic methodology is provided to carry out efficient storage and utilization of the TS data to aid in DSA and estimate system trajectories of concern. Exemplary inventive concepts of this disclosure include:
1. Establish motivation for utilizing scalable approaches such as low rank approximation in TS analysis.
2. Provide a systematic method to perform DSA by using the proposed SVD approach.
3. Validate the approach by comparing a few estimated system trajectories obtained from the inventive methods herein with the ones obtained through conventional simulation.

The rest of the disclosure is organized as follows: Section II provides trajectory sensitivity theory and issues with the original approach. Section III explains the forming and usage of a compressed SVD method. Section IV validates the method on IEEE 39 and WECC 179-bus test systems. Section V is the Conclusion section.

### II. Trajectory Sensitivitry Preliminaries

A power system can be represented by the following well known differential-algebraic equations:

$$\dot{x} = f ( x , y ; λ ) \qquad ( 1 )$$

$$0 = g ( x , y ; λ ) \qquad ( 2 )$$

In the above equations, x refers to the power system state and y refers to the algebraic variables. λ are the system parameters such as generator damping, inertia, and line reactance. The flows for system variables, x and y can be defined as follows:

$$x ( t ) = {ϕ}_{X} ( {x}_{o} , t , λ ) \qquad ( 3 )$$

$$y ( t ) = {ϕ}_{y} ( {x}_{o} , t , λ ) \qquad ( 4 )$$

In order to obtain the sensitivities of the flows of eqns. (3) and (4), a Taylor series approximation can be done given by eqns. (5) and (6):

$$Δ x ( t ) = \frac{\partial x ( t )}{\partial λ} Δ λ = {x}_{λ} ( t ) \cdot Δλ \qquad ( 5 )$$

$$Δ y ( t ) = \frac{\partial y ( t )}{\partial λ} Δ λ = {y}_{λ} ( t ) \cdot Δλ \qquad ( 6 )$$

From the eqns. above, x_{λ} and y_{λ} are time-varying matrices or TS of system state and algebraic variables, respectively. Using a time domain simulation approach, these sensitivities can be computed for a particular system condition through the following numerical procedure:

$${x}_{λ} = \frac{\partial x}{\partial λ} \approx \frac{{ϕ}_{x} ( {x}_{o} , t , λ + Δ λ ) - {ϕ}_{x} ( {x}_{o} , t , λ )}{Δ λ} \qquad ( 7 )$$

$${y}_{λ} = \frac{\partial y}{\partial λ} \approx \frac{{ϕ}_{y} ( {x}_{o} , t , λ + Δ λ ) - {ϕ}_{y} ( {x}_{o} , t , λ )}{Δ λ} \qquad ( 8 )$$

(7) and (8) use a perturbation-based approach to obtain TS. x_{λ} and y_{λ} are computed after perturbing parameters at a time instant, t_{perturb}.

Let T_{λ} be the appended TS matrix for the monitored system states and algebraic variables, such that T_{λ}=[x_{λ} y_{λ}]. For a system under study, considering p number of distinct parameter perturbations, let us assume parameter, λᵢ, ∀ᵢ∈1:p. Next, assuming m number of combined monitored states and algebraic variables and nₜ number of time steps from start of simulation till end time, t_{end}. This follows that TS sub-matrix for each distinct perturbation, T_{λ}_{ᵢ} =[x_{λ}_{ᵢ} y_{λ}_{ᵢ}]·T_{λ}_{ᵢ} is a data matrix of size nₜ×m. Hence, T_{λ} is composed of several T_{λ}_{ᵢ}, sub matrices, each of size nₜ×m, with size of T_{λ}=nₜ×(m·p). These sub matrices will increase in number with increased choice of perturbations. In this disclosure, the approach is explained by considering different perturbations but just one system fault condition per scenario in order to build T_{λ}.

Instead of storing T_{λ} as a mathematical expression of time, for this disclosure, we have time discretized it and stored the entries at different time steps (total of nₜ steps).

The system base case trajectory can be given as, X_{base}(t)=[X_{base}(t) y_{base}(t)]. We assume this to be a trajectory prior to applying parameter perturbation/s, irrespective of if the system was subjected to a large signal disturbance or not. After obtaining T_{λ}, perturbed trajectories, X_{updated}(t) for all monitored states, m, in response to desired λᵢ perturbation/s, can be formulated in a linearized manner as:

$${X}_{updated} ( t ) = {X}_{base} ( t ) + {\sum }_{i ∈ 1 : p} Δ {λ}_{i} \cdot {T}_{{λ}_{i}} ( t ) \qquad ( 9 )$$

(9) represents a generic formulation for all monitored states and algebraic variables, m. Also, in the formulation, T_{λ}_{ᵢ} has been expressed as function of t. This is to show that TS entries occupy the data matrix at discrete time steps. However, for simplicity, we can just depict it by ‘T_{λ}_{ᵢ}’ or ‘T_{λ}’, whichever applicable. In the above formulation, Δλᵢ is the magnitude of the desired specific parameter perturbation. In order to utilize linearized approach (9), value of Δλᵢ shall constitute as a small parameter perturbation.

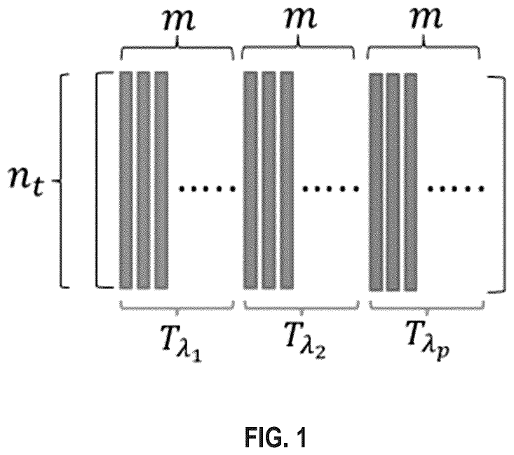

The size of T_{λ} can be quite large for a realistic test system, accommodating many monitored variables and distinct perturbations. As per findings, storage of T_{λ} can amount to a few gigabytes for a system with a few hundred buses considering a limited m and p. This can quickly go into several gigabytes of required storage capacity for a system with thousands of buses. Even if we assume the same number of time steps, nₜ, an increase in the system size and corresponding m and p sets, leads to a quadratic increase in size of T_{λ}. This is because how T_{λ} is originally formulated (FIG. 1). To add to that, its size will increase several times by accounting for different system conditions or fault scenarios.

These discussion points make it unrealistic to utilize T_{λ} in practical scenarios such as a scenario involving power system planning to aid in areas such as DSA. In addition to storage of T_{λ} being a major concern, its utility in quickly estimating trajectories or solving optimization problems by involving operations on magnanimous datasets, is also challenging. In order to address these drawbacks, it is essential to explore alternative storage and computational techniques involving T_{λ}.

### III. Low Rank Approximation of TS

In order to make TS analysis a practical and scalable approach in DSA, we explore the feasibility of accurately estimating perturbed system trajectories using low rank approximation of T_{λ}. By exploiting the widely available sophisticated computational methods, low rank approximation for a large system matrix can be conveniently performed using techniques such as singular value decomposition (SVD). Any input data matrix has an SVD, which uniquely defines it. The intuitive purpose is to efficiently store the matrix, T_{λ} while maintaining its system dynamics capturing ability. Further, the low rank approximation is planned to accurately predict the perturbed system trajectories, given by X_{updated}(t) in (9), in response to chosen and varying Δλᵢ.

The input data matrix or the TS matrix in this case, T_{λ} can be expressed in its SVD form as follows:

$${[ \begin{matrix}\vert & \vert & \vert & \vert \\ {T}_{{λ}_{1}} & {T}_{{λ}_{2}} & … & {T}_{{λ}_{m}} \\ \vert & \vert & \vert & \vert\end{matrix} ]}_{{n}_{t} \times ( m \cdot p )} = U S {V}^{T} \\ wherein , \qquad ( 10 )$$

$$U S {V}^{T} = {[ \begin{matrix}\vert & \vert & \vert & \vert \\ {u}_{1} & {u}_{2} & … & {u}_{m \cdot p} \\ \vert & \vert & \vert & \vert\end{matrix} ] [ \begin{matrix}{σ}_{0} & 0 & - & 0 \\ \vert & {σ}_{2} & \vert & \vert \\ \vert & 0 & \vert & \vert \\ 0 & - & - & {σ}_{m \cdot p}\end{matrix} ] [ \begin{matrix}\vert & \vert & \vert & \vert \\ {v}_{1} & {v}_{2} & … & {v}_{m \cdot p} \\ \vert & \vert & \vert & \vert\end{matrix} ]}^{T} \qquad ( 11 )$$

‘m·p’ are the number of linearly independent columns. U and V are orthonormal matrices such that UU^{T}=I₍ₙ_{ₜ}_{×n}_{ₜ}₎, U^{T}U=I_{(m·p)×(m·p)}, VV^{T}=V^{T}V=I_{(m·p)×(m·p)}. Matrix U is hierarchically arranged in terms of its ability to describe variance in columns of T_{λ}. Similarly, S is a diagonal matrix composed of non-negative singular values and is hierarchically ordered, with σ₁≥σ₂≥ . . . ≥σ_{m·p}. The intuitive understanding for the above formulation is that the first column of U and V corresponding to σ₁ are most important to capture the underlying dynamics of T_{λ}, followed by σ₂ and so on.

T_{λ} can be approximated by truncating its SVD formulation at a certain rank, k_{truncate} to obtain and store new condensed matrices U_{new}, S_{new} and V_{new}. These matrices shall be able to effectively capture the dynamics of T_{λ}. To achieve this, firstly, T_{λ, k} is computed at different ranks, k. Next, % errors and compression factors are computed for the different k. The compression factor, as the name suggests, provides a factor by which condensed matrices obtained through SVD technique are lesser in size compared to T_{λ}. The formulation is as follows: ∀k=1, 2, . . . , min (nₜ, m·p):

$${T}_{λ , k} = U ( : , 1 : k ) \cdot S ( 1 : k , 1 : k ) \cdot {V ( : , 1 : k )}^{T} \qquad ( 12 )$$

$$\% error = \frac{‖ {T}_{λ} - {T}_{λ , k} ‖}{‖ {T}_{λ} ‖} \times 100 \qquad ( 13 )$$

$$Compression factor = \frac{{n}_{t} \cdot ( m \cdot p )}{( {n}_{t} \cdot k ) + k + ( k \cdot ( m \cdot p ) )} \qquad ( 14 )$$

Where ∥T_{λ}∥ is the norm of the TS matrix. The value of nₜ can be reduced if DSA needs to be done for a lesser time window. However, for obtaining results in this disclosure, we assume t_{end}=10 seconds and hence a fixed value of nₜ.

In the present disclosure, we chose k_{truncate} to be at a value when % error between actual and condensed TS matrix<0.01%, which is a conservative choice. There is no definite rule to determine k_{truncate}. It can be tuned as per insight of the system operator or planner based on but not limited to—intuition of the planner about the physics of the grid in different areas, the severity of various fault scenarios opted in planning studies and the typical dynamic behavior and sensitivities observed for crucial monitoring quantities for diverse scenarios. The tradeoff between a particular % error value and its corresponding compression factor needs to be understood well considered prior to choosing k_{truncate}.

After condensing the original U, S and V matrices at k_{truncate}, let T_{λ,k}_{_{truncate}}=U_{new}·S_{new}·V_{new}. Now, (9) can be modified to accommodate the proposed SVD approach:

$${X}_{updated} ( t ) = {X}_{base} ( t ) + {SVD}_{perturb} \qquad ( 15 )$$

$${SVD}_{perturb} = {U}_{new} \cdot {S}_{new} \cdot {\sum }_{i ∈ 1 : p} Δ {λ}_{i} \cdot {V}_{new}^{i} ( : , 1 : m ) \qquad ( 16 )$$

In (16), superscript, ‘i’ with V_{new} is to depict a unique perturbation set and we assume monitoring all the states and algebraic variables, m, associated to that set. This is similar to the assumption made in (9). The desired perturbation set, and its associated varied or unlearned Δλᵢ can be chosen by the system planner or operator to determine X_{updated}(t).

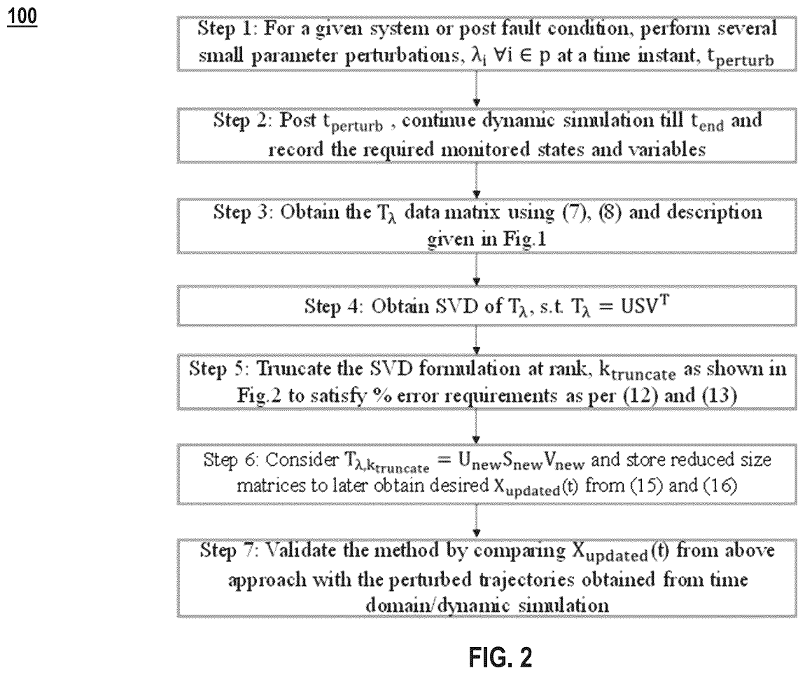

The method is summarized in FIG. 2 and can be implemented using widely available dynamic simulation and data analytics tools. We used PSS/E Python interface for dynamic simulations and MATLAB for data analytics to implement the approach.

### IV. Numerical Simulation Results

In order to test and validate the approach discussed in Section III, we mainly consider explaining the method and results on IEEE 39-bus test system and later validate it on the WECC 179-bus system.

### A. Test System and Scenarios for IEEE-39 Bus System

In order to test and validate the approach discussed in Section III, we first consider the 10 machine IEEE 39-bus system. It has 10 generators and 46 lines with detailed dynamic models invoked for all generators, including governors and exciters (GENROU, IEEEG2 and IEEET1 respectively). To test the approach, firstly a three phase fault of 0.6 seconds was created at bus 32 or location of generator 3, with clearing time instant, t_{cleared}=2.6 seconds. The system parameters were perturbed at an arbitrary post fault instant, t_{perturb}=3.6 seconds and dynamic simulation was terminated at t_{end}=10 seconds. The T_{λ} for this fault scenario was retrieved through steps 1 to 3 in FIG. 2 by perturbing different sets of parameters and monitoring generator rotor angles, δ, speed deviations, ω and all bus voltages. This accounted for a total of 59 monitoring variables. For the different perturbations, small perturbations were assigned to inertia and damping coefficient of each generator (2×10 perturbations), governor gains of each machine (10 perturbations), loads at buses 3, 4, 12, 15 and 21 and reactance of five of the lines. This accounted for a total of 40 perturbations to build the full TS matrix, T_{λ} for the specific fault scenario described above.

The size of T_{λ} data matrix for this scenario is 3710×(59·40) or approximately 8.76 million entries, considering the dynamic simulation time step of 0.003 s.

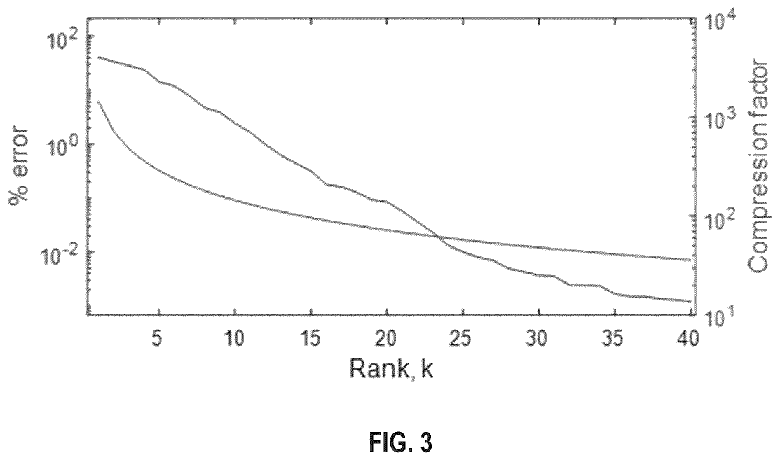

The SVD of T_{λ} is obtained and the % error and compression factor formulation given by (12), (13) and (14) are used to determine k_{truncate}. FIG. 3 shows the plot of % error and compression factor vs. k or singular value indices.

We have discussed the selection of k_{truncate} in Section III and for the validation of the proposed approach in the subject disclosure, k_{truncate} is chosen when % error <0.01%. We let k_{truncate}=30 for validating results for the IEEE 39-bus system. At this rank, the error is precisely 0.0037% and compression factor is 48.07, which is quite significant. At k_{truncate}=30, Step 6 given in FIG. 2 can be performed to obtain and store U_{new}, S_{new} and V_{new}. In order to further assess the validity of the approach, it is essential to confirm its applicability to predict the state and voltage trajectories after perturbing multiple system parameters.

### B. Validation of Compressed SVD Approach—39 Bus System

In order to validate the approach, different parameter perturbations with varied Δλᵢ, are considered to estimate X_{updated}(t). The trajectories obtained are then compared with results obtained from non-linear dynamic simulation. In this disclosure, 14 of the original 40 distinct parameter perturbations are considered, as summarized in Table I. In comparison to the small perturbation values used to obtain T_{λ}, the values in Table I are considered much higher to show the practicality of this approach in estimating X_{updated}(t). However, it is to be noted that this approach by itself is independent of the requirement of small perturbations. That requirement is natural to TS based analysis, which is a linearized analysis.

TABLE I
Custom perturbations considered for approach validation

| Parameter perturbation description | Δλᵢ | |
|---|---|---|
| Inertia, H, at gen 4, 9 and 8 | + 0.6, +1.6 and +1.5 | |
| Damping, D, at gen 3 and 4 | +0.3 | each |
| Governor gain, K, at gen 3 and 6 | +15% | each |
| Loads at buses 3, 12, 15 and 21 | +15% | each |
| Reactance of three lines from | +20% | each |

| | |
|---|---|
| buses 4-14, 10-13, and 3-18 | |
| Total no. of distinct perturbations | 14 |

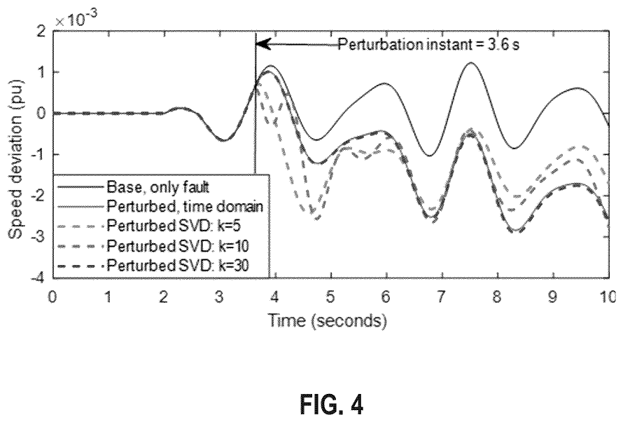

As an example, to verify the method, FIG. 4 below shows the speed deviation trajectories of Gen 6 (Bus 35). The plot includes trajectory for just the faulted case (X_{base}(t)), perturbed trajectories, X_{updated}(t) obtained from time domain simulation and at various k_{truncate} using the SVD approach.

The stark difference in speed deviation trajectory plots for Gen 6 can be well observed in FIG. 4. ‘Base, only fault’ depicts just the post fault trajectory, X_{base}(t), whereas the remaining trajectories are perturbed at t_{perturb}. It can be seen that X_{updated}(t) obtained from time domain simulation matches quite well with the inventive SVD approach for chosen k_{truncate}=30.

Next, Table II below quantifies the maximum error recorded for X_{updated}(t) for bus voltages, generator relative rotor angles and speeds for k_{truncate}=10, 20 and 30 for this study case. This error is the maximum difference between the X_{updated}(t) for different variables, obtained from the SVD approach and time domain simulation.

TABLE II
Maximum error recorded for perturbed system trajectories

| Monitored variable | k = 10 | | k = 20 | | k = 30 | |
|---|---|---|---|---|---|---|
| Voltage | 0.0011 | pu | 8.82E⁻⁴ | pu | 7.40E⁻⁴ | pu |
| Gen speed | 0.0014 | pu | 1.61E⁻⁴ | pu | 1.59E⁻⁴ | pu |
| Gen relative δ | 0.019 | rad | 0.016 | rad | 0.016 | rad |

It can be seen from FIG. 4 and Table II that the maximum error is insignificant for k_{truncate}=30. This justifies the choice herein to assume k_{truncate}=30 to estimate trajectories in the remaining disclosure.

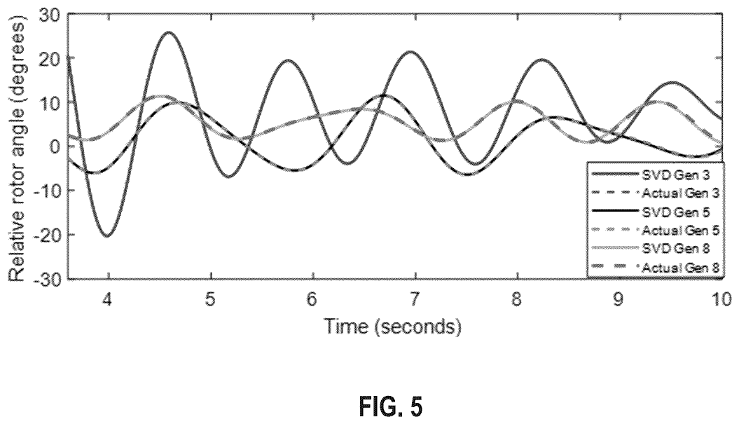

We also compare a few of the X_{updated}(t) of generator relative & from the SVD approach with ones obtained from time domain simulation, which are termed as ‘Actual’ in the plots below. The plots begin at time, t_{perturb} to compare and estimate post fault trajectories. It is evident from FIG. 5 that the proposed SVD approach successfully estimates X_{updated}(t) as per the desired perturbations.

### C. Validation on WECC 179 Bus, 29 Machine System

Our approach is also tested for scalability on the reduced WECC 179 bus test system. We replaced the GENCLS model with GENROU and invoked additional dynamic models (exciter SEXS and TGOV1) for all the 29 machines. In order to build the TS matrix, we consider perturbations to the inertia, damping, exciter gains at all generator buses as well as 20 of the 500 KV lines. This accounts for a total of 107 perturbations.

We account for 237 monitoring states or variables per perturbation set—generator terminal voltages, speed deviations and bus voltages at all the buses. Two fault scenarios are considered—1) three phase fault at bus 3 (non-generator bus) with t_{fault}=0.1 s, t_{cleared}=0.18 s and t_{perturb}=0.22 s. 2) three phase fault at bus 144, a generator bus with t_{fault}=0.3 s, t_{cleared}=0.4 s and t_{perturb}=0.44 s.

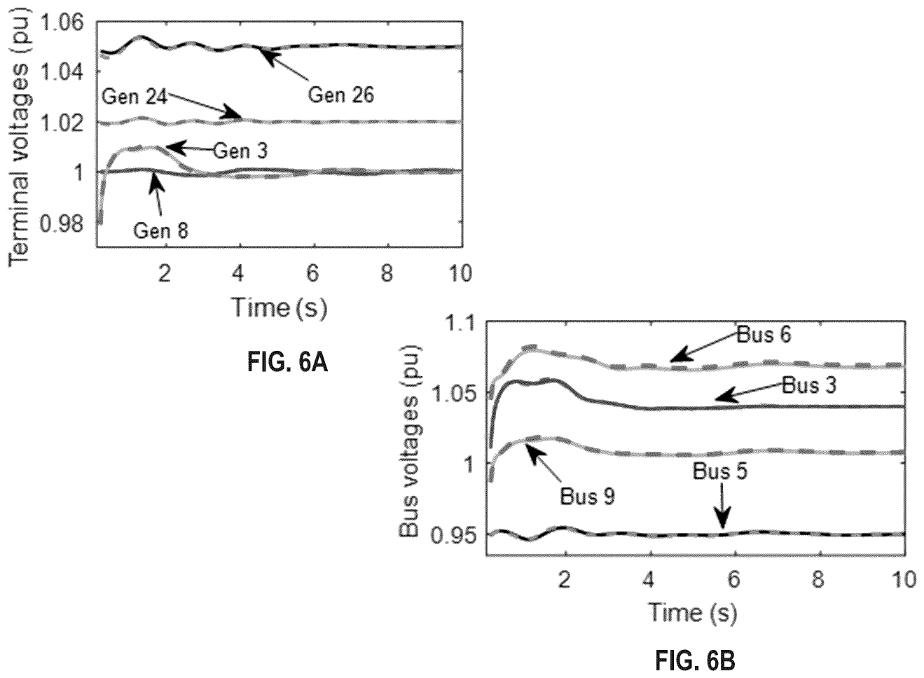

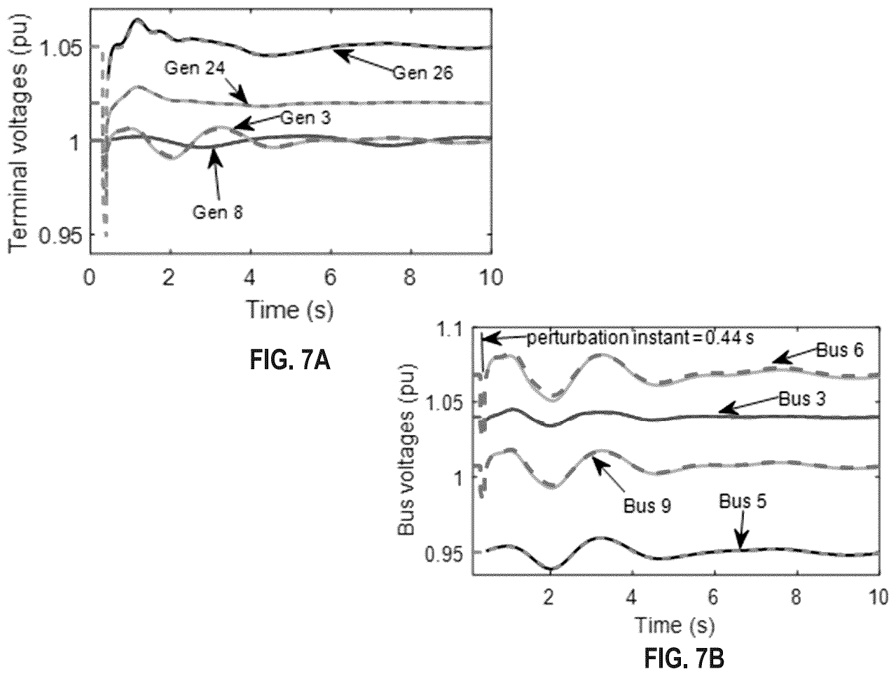

At the chosen dynamic simulation time step of 0.003 s, the TS matrix has 3710×(237·107) or approximately 94.08 million entries. Each fault scenario or system condition corresponds to a different TS matrix. Using eqns. (12)-(14) and the conservative assumption of % error<0.01 for this disclosure, k_{truncate} is chosen as 50, for both the fault scenarios. This provides a compression factor of about 65 (eq. 14). In terms of absolute data storage advantage, post the truncation, the size of TS dataset for this study reduced from about 718.6 to 11.2 MB. For validation of approach to aid in DSA, a set of 20 perturbations are assigned at once. These comprise of small perturbations to the inertias of 8 of the generators and appreciable magnitudes of perturbation to reactance of twelve 500 KV lines, ranging from +30% to +50%. The comparison of a few random perturbed system trajectories with the time domain simulation results for the two fault scenarios is presented in FIGS. 6 and 7 below (k_{truncate}=50).

In contrast to the IEEE 39-bus system wherein t_{perturb}=3.6 s, for this larger system, we perturbed the parameters prior to 0.5 seconds in both the scenarios. Hence the TS matrix for this system is populated almost right from the start till t_{end}=10 s. Despite of the large time gap in t_{perturb} for the two systems, the compression factor obtained for WECC 179-bus system is much greater than IEEE 39-bus system (65 vs. 48). This observation further points towards the immense potential of scalability of the proposed approach to aid in TS based DSA on much larger systems. The validation plots above are also for a larger magnitude and a greater number of simultaneous perturbations compared to the 39-bus system.

The method was tested for multiple perturbations on IEEE 39 bus and WECC 179 bus system and in all the situations, the SVD-TS based reconstruction matched the actual non-linear response with <0.01% error. Thus, using this approach, one can perform DSA by identifying approximate threshold limits of the monitored system states and algebraic variables in response to different parameter perturbations, following a critical system condition such as a three-phase fault or a crucial line trip.

### V. Conclusions

The inventive concepts described herein comprise a first step to address a pertinent issue relating to practical usage of TS analysis in DSA, i.e., efficient storage of TS data. It is shown that low rank compression using SVD can be effectively applied to TS datasets and aid in DSA. The method was validated on IEEE 39-bus test system and WECC 179-bus system with TS data matrix compression of approximately 48 and 65 times respectively. For the WECC 179-bus system, the size of TS dataset for the study reduced from 718.6 MB to about 11.2 MB while being able to accurately estimate perturbed system trajectories.

It will be interesting to test the approach on a much larger test system with high penetration of IBRs. This will offer a wide choice of monitoring variables and system perturbations to build the TS dataset. As a future work, we are also working on evaluating other alternate solutions for efficient TS data management on larger systems and its utilization in DSA.

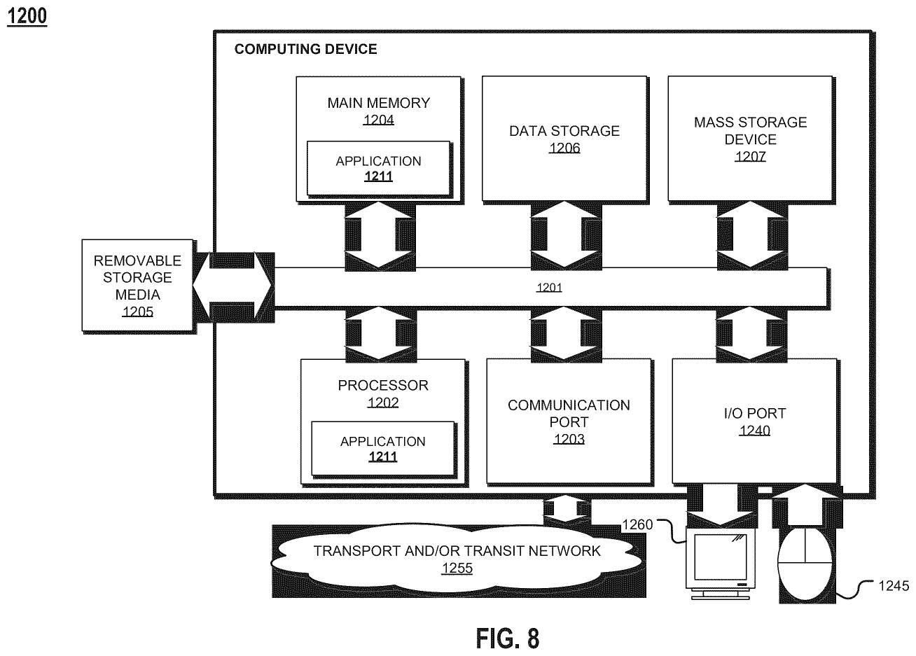

Exemplary Computing Device: Referring to FIG. 8, a computing device 1200 is illustrated which may can be configured, via one or more of an application 1211 or computer-executable instructions, to execute functionality described herein. More particularly, in some embodiments, aspects of the methods herein may be translated to software or machine-level code, which may be installed to and/or executed by the computing device 1200 such that the computing device 1200 is configured to execute functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

The described methods, processes, operations, and associated actions may also be performed in various orders in addition to the order described in this application, in parallel, and/or simultaneously. The described systems are exemplary in nature and may include additional elements and/or omit elements. Furthermore, references to or “one example” of the present disclosure are not intended to be interpreted as excluding the existence of additional embodiments that also incorporate the recited features. It will be understood that when a certain part or process “includes” a certain component or operation, that part or process does not exclude another component or operation. While illustrative examples of the name screening techniques using phonetic embeddings have been described herein including systems, devices, and the like, it is to be understood that various other adaptations and modifications may be made within the spirit and the scope of the examples herein. Additionally, it is appreciated that while specific graphics are shown and described, such graphics are illustrative and exemplary and are not intended to limit the scope of this disclosure.

The foregoing description has been directed to specific examples. It will be apparent, however, that other variations and modifications may be made to the described examples, with the attainment of some or all of their advantages. For instance, it is expressly contemplated that the components and/or elements described herein can be implemented as software being stored on a tangible (non-transitory) computer-readable medium, devices, and memories (e.g., disks/CDs/RAM/EEPROM/etc.) having program instructions executing on a computer, hardware, firmware, or a combination thereof. Further, methods describing the various functions and techniques described herein can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures. Accordingly, this description is to be taken only by way of example and not to otherwise limit the scope of the examples herein. Therefore, it is the object of the appended claims to cover all such variations and modifications as come within the true spirit and scope of the examples herein.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method for using low rank compression of trajectory sensitivities (TS) for efficient dynamic security assessment, comprising:
accessing data associated with a system; and
conducting, by a processor and leveraging the data, dynamic simulation associated with the system, by:
performing a plurality of small parameter perturbations λᵢ∀i∈p at a time instant t_{perturb}:
post t_{perturb}, continuing dynamic simulation till tend and recording a required monitored states and variables,
generating a trajectory sensitivity (TS) matrix, T_{λ},
obtaining a singular value decomposition of T_{λ},
truncating the singular value decomposition at rank k_{truncate} to satisfy predetermined error requirements,
consider let T_{λ,k}_{_{truncate}}=U_{new}·S_{new}·V_{new} and store reduced size matrices to later obtain a desired X_{updated}(t), and
validating by comparing X_{updated}(t) with perturbed trajectories obtained from time domain/dynamic simulation of the system.

2. A method for using low rank compression of trajectory sensitivities (TS) for efficient dynamic security assessment, comprising:
accessing an input data matrix associated with trajectory sensitivity for a power system;
expressing the input data matrix associated in a singular value decomposition (SVD) form, the SVD form defining a plurality of matrices;
truncating the SVD form of the input data matrix at a certain rank to obtain and store new condensed matrices according to predetermined error requirements, the new matrices configured to efficiently capture dynamics of the input data matrix;
consider the SVD form of the input data matrix as truncated being equal to the new matrices to compute a unique perturbation set.

3. The method of claim 2, further comprising:
validating the unique perturbation set by comparing output from the power system using the unique perturbation set with perturbed trajectories obtained form time domain/dynamic simulation.

4. The method of claim 2, wherein the SVD form of the input data matrix is truncated, by:
computing truncation at different ranks, and
computing percentage errors and compression factors for each different rank.

5. A system for low rank approximation of trajectory sensitivity, comprising:
a memory storing instructions, and
a processor that accesses the instructions in the memory to efficiently store a matrix T_{λ} associated with a power system while maintaining its system dynamics capturing ability via low rank compression using singular value decomposition (SVD), wherein the processor:
obtains the SVD of the matrix T₈₀ ,
computes % error and compression factor formulation to determine k truncate when the % error<0.01%, and
obtains and stores in the memory new condensed matrices, the new condensed matrices configured to predict a state and trajectories after perturbing multiple system parameters of the power system.
